(19) United States
(12) Patent Application Publication
(10) Pub. No.: US 2022/0065395 A1
(43) Pub. Date: Mar. 3, 2022

(54) Orientation Block Assembly

(71) Applicant: Hitachi Cable America Inc., Purchase, NY (US)

(72) Inventors: David A. Galey, Saint Croix, IN (US); Ross A. Worrall, Floyds Knobs, IN (US)

(21) Appl. No.: 17/010,470

(22) Filed: Sep. 2, 2020

(51) Int. Cl. F16M 13/02; F16L 3/02

(52) U.S. Cl. CPC F16M 13/022; B60T 17/043; F16M 2200/024; F16L 3/02

(57) ABSTRACT

This specification describes an orientation block apparatus and assembly for aligning and orienting a brake fluid line and its integral fitting to a structure.

### BACKGROUND OF THE INVENTION

The system described herein relates generally to an apparatus for orienting a supply line in a mechanical system and more specifically to an assembly for aligning and orienting a brake fluid line and its integral fitting in an automotive braking system. The present invention features a novel apparatus for mounting and aligning a cylindrical fitting of a brake line system to a mounting location on a vehicle without limiting a user to a single orientation.

In conventional braking systems rigid brake lines are typically routed from a pressurized fluid supply system to a braking system component such as a brake caliper and piston assembly. Rigid brake lines are often used in these systems to provide a high degree of hydraulic system integrity and durability from the elements, vibration, dirt, dust, and corrosion. Accordingly, a rigid line must be routed from the source of pressurized hydraulic fluid, for example a master cylinder in many automotive systems, to the brake components mounted proximate the wheels of the vehicle. These rigid lines have a plurality of turns and bends in them to provide routing around various components and structures and accordingly must be precisely manufactured in order to mate on both ends of the system.

Typically these rigid lines are mounted to a portion of the structure proximate the point where they mate to the hydraulic system. However, even in precisely manufactured rigid lines, due to manufacturing tolerances and the inherent differences in complex mechanical structures it is quite difficult to route each line perfectly so that it mates with the hydraulic system and can be readily mounted to a surface nearby.

Accordingly, one disadvantage with prior art rigid brake line systems is the difficulty in routing and mounting these rigid lines consistently from one vehicle or application to the next. Furthermore if an individual brake component mounting structure is in a slightly different location or orientation, orienting the rigid line with respect to that mounting structure or surface can become quite difficult, resulting in increased labor and installation time and of course the attendant associated costs.

Accordingly, there is a need for an orientation block assembly used in conjunction with a rigid line or component for mounting to a structure that enables the mounting surfaces of each to mate without bending the line or reorienting the structure mounting surface.

### SUMMARY OF THE INVENTION

In various aspects and embodiments the invention described herein provides a novel orientation block assembly for mounting a component to a structure. The embodiments described herein are capable of being used in a conventional automotive braking system having a brake line for supplying pressurized brake fluid that terminates in a component, for example a cylindrical eyelet fitting, and is then mounted to structure. A wide variety of embodiments and uses may be employed implementing the apparatus and system of the invention utilizing a variety of structures without departing from the teachings of this specification.

In some aspects and embodiments the orientation block assembly may include an orientation block including a mounting surface that contacts or abuts a structure. In some embodiments the orientation block may be positioned to abut or contact the structure at a plurality of contact points and thus be precisely positioned or oriented with respect to component. The mounting surface may in some embodiments be shaped or profiled to engage a specific structure shape depending on the application of the assembly. In many embodiments a wide variety of mounting surface shapes may form a part of orientation block without departing from the scope of the invention.

In various embodiments and aspects the orientation block may have a plurality of sides around its perimeter and an engagement surface that is shaped to engage a complementary exterior surface of the component. In some non-limiting embodiments the component may be an eyelet fitting having a generally annular shape and including a raised annular exterior surface that is interrupted by an aperture through which a brake fluid line may be routed and secured in a fluid-tight fashion

In some embodiments the engagement surface of the orientation block is a recessed annular surface that is bounded on the sides thereof by a pair of semi-cylindrical walls. In some aspects this recessed annular surface has a circumference that mates closely with and is shaped to be engaged by the complementary raised annular exterior surface of the eyelet fitting, thereby permitting close engagement of the orientation block and eyelet fitting.

In further aspects the system is capable of allowing the eyelet fitting to be rotated within the orientation block so that the recessed annular surface of block and the raised annular surface of the fitting can move relative to each other, to provide a plurality of orientations for the fitting. In these embodiments, any line that is fitted into the aperture may be oriented in a plurality of positions without changing the structure or design of the orientation block or line.

As used herein for purposes of the present disclosure, the term “component” can be used to refer to any structure that requires orientation for mounting or position. In many embodiments this specification will refer to a component as a part of an automotive braking system, for example a cylindrical eyelet fitting. However any of a wide variety of components may be utilized with the concepts and embodiments of the invention as taught herein without limiting the scope of the invention.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other advantages and features, which characterize the embodiments, are set forth in the claims appended hereto and form a further part thereof. However, for a better understanding of the embodiments and of the advantages and objectives attained through their use, reference should be made to the Drawing Figures and to the accompanying specification, in which there are described exemplary embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWING FIGURES

In the drawings, like reference characters generally refer to the same parts throughout the different views. Also, the drawings are not necessarily to scale, emphasis instead generally being placed upon illustrating the principles of the invention.

FIG. 1 is a perspective view of an orientation block assembly and fluid supply line in accordance with various embodiments;

FIG. 2 is a perspective view of an orientation block assembly and fluid supply line in accordance with various embodiments;

FIG. 3 is perspective view of an orientation block and fitting assembly in accordance with various embodiments;

FIG. 4 is a perspective view of an orientation block and fitting assembly in accordance with various embodiments;

FIG. 5 is a perspective view of an orientation block in accordance with various embodiments;

FIG. 6 is a perspective view of an orientation block and fitting assembly in accordance with various embodiments;

FIG. 7 is a perspective view of an orientation block and fitting assembly in accordance with various embodiments;

FIG. 8 is a perspective view of an orientation block and fitting assembly in accordance with various embodiments;

FIG. 9 is a perspective view of an orientation block and fitting assembly in accordance with various embodiments; and

FIG. 10 is a perspective view of an orientation block and fitting assembly in accordance with various embodiments.

### DETAILED DESCRIPTION OF THE PREFERRED EMBODIMENT(S)

Numerous variations and modifications of the apparatuses and embodiments of the disclosed invention will be apparent to one of ordinary skill in the art, as will be readily seen from the detailed description of the system set forth below. Therefore, the invention is not limited to the specific implementations discussed herein.

Furthermore, the embodiments discussed herein will focus on the implementation of the described techniques and apparatuses for an orientation apparatus for mounting a component to a structure. While the embodiments described herein will refer generally to implementation of an orientation block for orienting a hard supply line such as a brake fluid supply line to a structure, one of ordinary skill will recognize that the invention may be practiced with a broad array of lines or other components that require orientation during assembly without departing from the scope thereof.

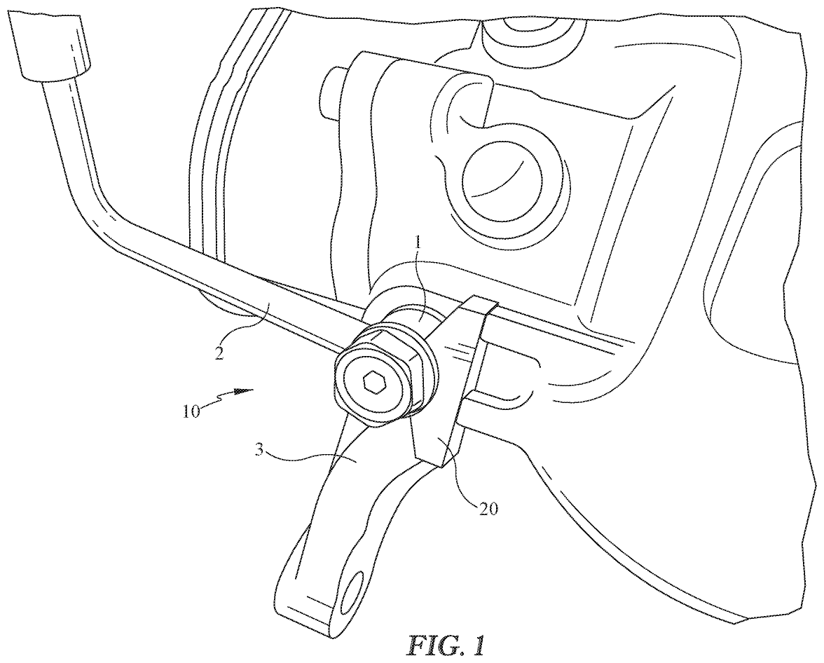

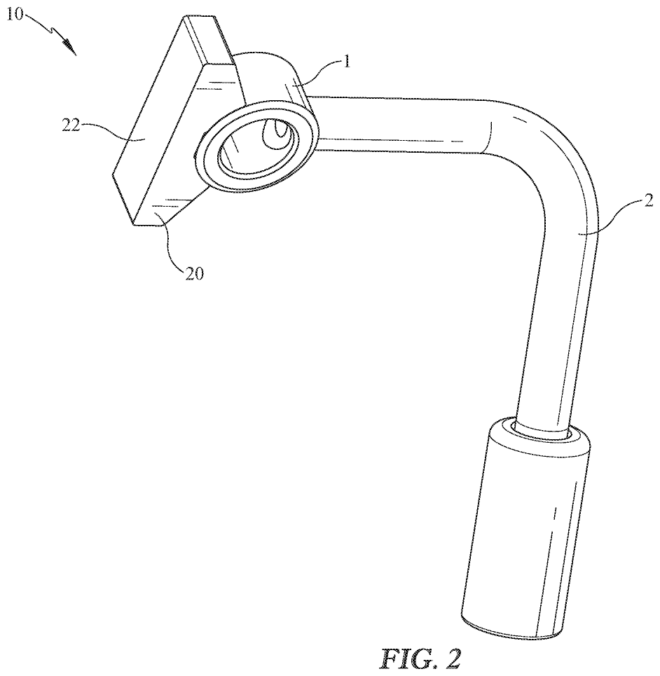

Referring now to drawing FIGS. 1-3 and in accordance with various aspects and embodiments, herein is described a novel and orientation block assembly 10 for mounting a component 1 to a structure 3. One of ordinary skill in the art will recognize that a wide variety of components 1 and structures 3 may be employed in conjunction with the present invention without departing from the scope thereof. For example, the embodiments described herein are capable of being employed and/or adapted for use in a conventional automotive braking system wherein a brake line 2 for supplying pressurized brake fluid terminates in a cylindrical eyelet fitting 1 (component) and is then mounted to a brake caliper or a component thereof (structure), as depicted in FIG. 1. However, many other embodiments and uses may be employed implementing the apparatus and system of the invention utilizing a variety of structures without departing from the teachings of this specification.

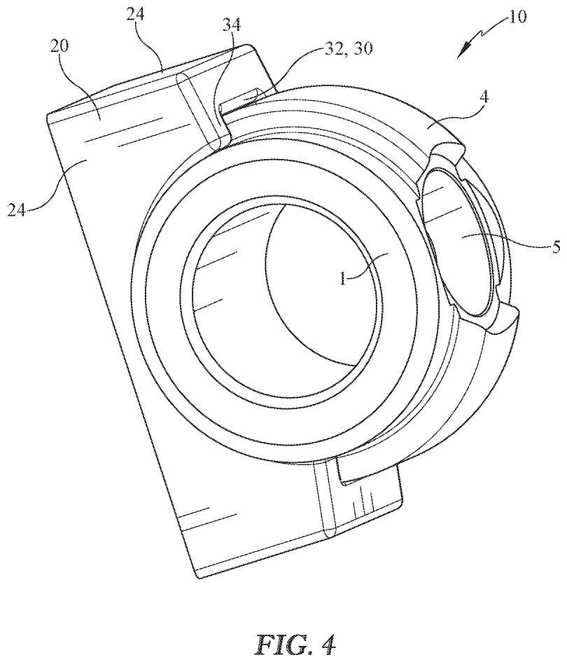

Orientation block assembly 10 may in some aspects and embodiments include an orientation block 20 that comprises a mounting surface 22 for contacting or abutting a structure 3. As best seen in FIG. 1, orientation block 20 may be positioned to abut or contact structure 3 at a plurality of contact points whereby orientation block 20 is specifically positioned or oriented with respect to component 1. Furthermore, mounting surface 22 may be shaped or profiled to engage a specific structure shape depending on the application of assembly 10. As will be readily seen from the various embodiments depicted in FIGS. 4-10 a wide variety of mounting surface 22 shapes may form a part of orientation block 20 without departing from the scope of the invention.

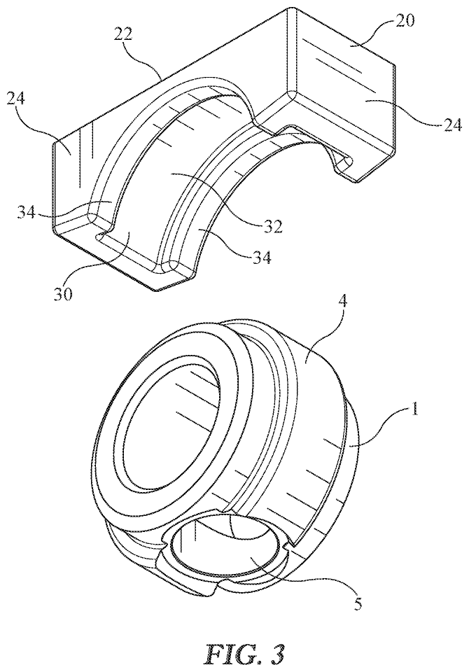

Referring now to FIGS. 1-4 and in various embodiments orientation block 20 may further include a plurality of sides 24 around a perimeter thereof, and an engagement surface 30 that is shaped to engage a complementary exterior surface 4 of component 1. As best seen in FIGS. 3 and 4 and in one non-limiting embodiment component 1 may be an eyelet fitting 1 having a generally annular shape and including a raised annular exterior surface 4 that is interrupted by an aperture 5 through which a line 2 may be routed and secured in a fluid-tight fashion. This eyelet fitting 1 is often found as a component 1 in automotive braking systems. In the embodiment of FIG. 3, engagement surface 30 of orientation block 20 is a recessed annular surface 32 that is bounded on the sides thereof by a pair of semi-cylindrical walls 34. Recessed annular surface 32 is provided with a circumference that mates closely with and is shaped to be engaged by the complementary raised annular exterior surface 4 of eyelet fitting 1, thereby permitting close engagement of orientation block 20 and eyelet fitting 1. As can be seen from FIGS. 3 and 4 eyelet fitting 1 may be rotated within the orientation block 20 such that recessed annular surface 32 of block 20 and raised annular surface 4 of fitting 1 move relative to each other, to provide a plurality of orientations for fitting 1 and thus aperture 5. Accordingly, any line 2 that is fitted into aperture 5 may be oriented carefully toward its other terminus, thus providing an assembly 10 that may be utilized to orient fitting 1 in a plurality of positions without changing the structure or design of orientation block 20 or of line 2.

In many applications orientation block assembly 10, including orientation block 20 and component 1 are both comprised of a corrosion resistant metal alloy such as stainless steel, plated carbon steel after processing braze, and similar alloys. In other embodiments orientation block 20 and component 1 may be constructed of plastics, carbon fiber, or any relatively rigid material without departing from the scope of the invention. In some aspects and embodiments orientation block 20 is positioned such that mounting surface 22 is properly positioned for securing on structure 3 and fitting 1 is then oriented to provide the desired location and/or orientation for eyelet fitting 1 and line 2 within orientation block 20. Once properly positioned, orientation block 20 and fitting 1 are then secured permanently together by brazing, welding, adhesives, press-fitting, or any other equivalent technique for securing similar materials together, such that the orientation of block 20 and component 1 remains fixed for further assembly. Additionally, mounting surface 22 of orientation block 20 is then secured to structure 3 by a suitable technique, including but not limited to welding, brazing, adhesive, fasteners and press-fitting.

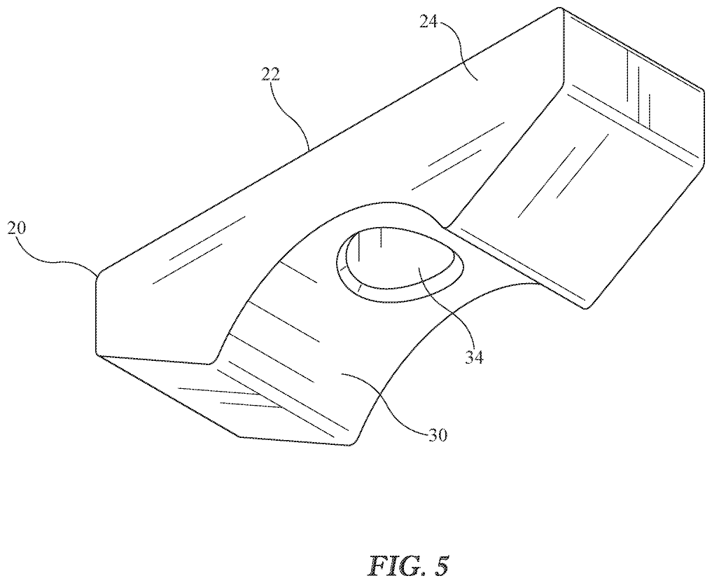

Referring now to FIG. 5 and in accordance with some exemplary but non-limiting embodiments of the invention orientation block 20 may be provided with an engagement surface 30 having a semi-cylindrical shape and an aperture 34 therein, through which a fluid supply line 2 may be routed to connect with component 1. In these embodiments engagement surface 30 is shaped to engage the cylindrical exterior surface 4 of component 1. Surface 30 may be shaped to engage a wide variety of component exterior surfaces 4 without departing from the scope of the invention.

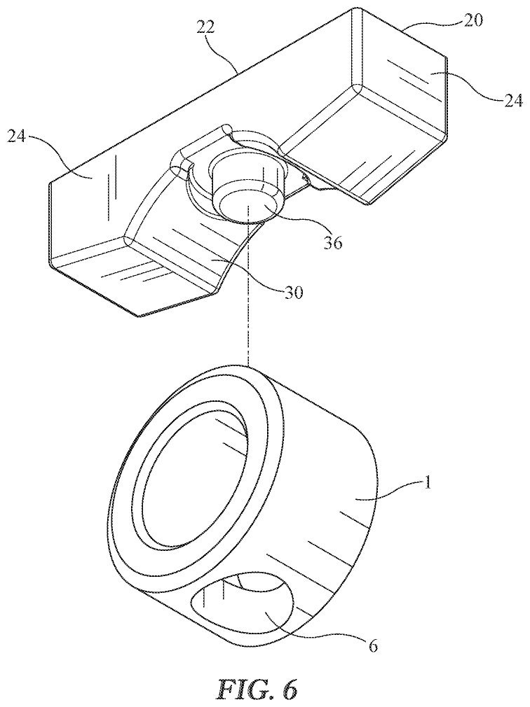

In accordance with some embodiments and as best seen in FIG. 6, orientation block 20 may comprise a generally semi-cylindrical engagement surface 30 having a post or tab 36 extending outwardly from a portion thereof. In some embodiments post 36 is generally cylindrical and is shaped to engage a complementary aperture 6 that is recessed into an exterior surface of component 1, depicted in FIG. 6 as an eyelet 1. Orientation block 20 post 36 is positioned within aperture 6 of eyelet 1 such that block 20 may then be rotated around eyelet 1 to orient eyelet 1 with respect to a structure 3. In some embodiments aperture 6 may be elongated to permit a range of orientations of post 36 in aperture 6, thereby permitting a range of positions for orientation block 20.

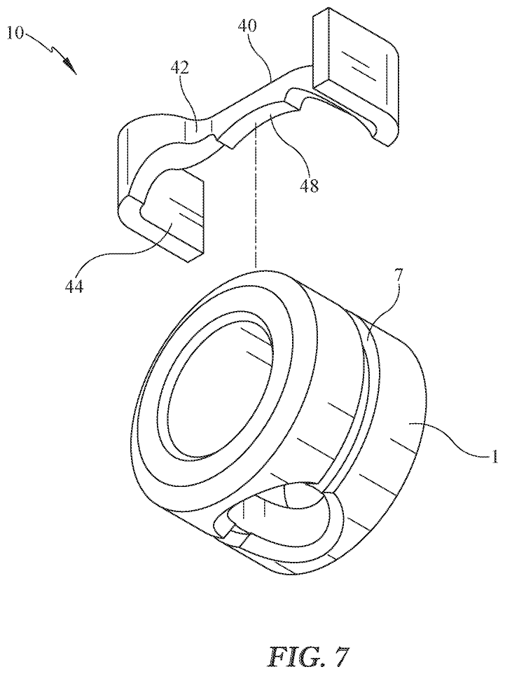

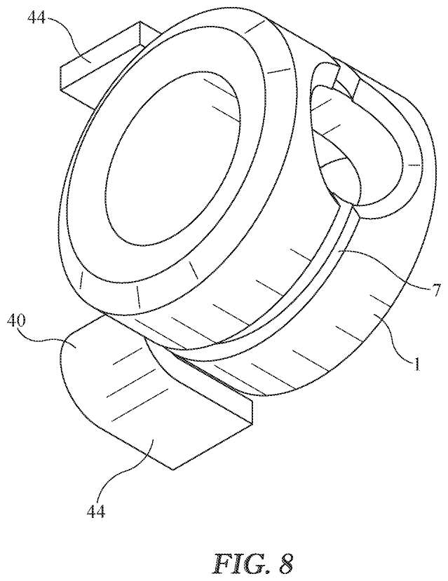

Referring now to FIGS. 7 and 8 and in accordance with some exemplary embodiments orientation apparatus 10 may include a component 1 or eyelet 1 that includes an annular groove 7 recessed around at least a portion of the exterior surface of eyelet 1. Instead of an orientation block 30, an orientation tab 40 is provided, having a body portion 42 that connects a pair of opposed engagement tabs 44 at either end thereof. An arcuate or curved groove engagement portion 48 is disposed along an edge of body portion 42, connecting engagement tabs 44, and is shaped to engage the complementary annular groove 7 of eyelet 1. When oriented around eyelet 1 body 42 and/or engagement tabs 44 may be positioned to abut or contact structure 3, thereby providing proper orientation for eyelet 1. It should be noted that groove 7 and groove engagement portion 48 may be formed from a wide variety of shape profiles without departing from the scope of the invention.

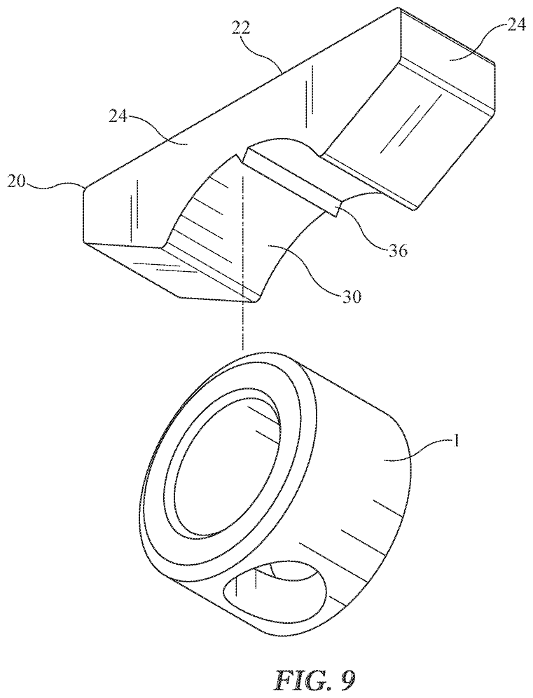

Referring now to FIG. 9, and in accordance with some embodiments of the invention orientation block 20 may comprise a generally semi-cylindrical engagement surface 30 having a sacrificial weld tab 36 extending outwardly from a portion thereof. In some embodiments tab 36 is generally triangular in cross-section and is provided to permit welding at any location once block 20 is properly oriented. Of course tab 36 may have a variety of cross-sectional complementary shapes without departing from the scope of the invention.

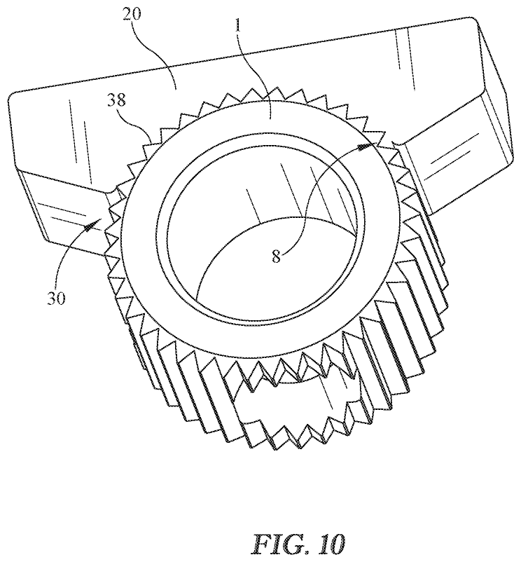

Referring now to FIG. 10 and in accordance with some aspects and embodiments orientation block 20 may have an engagement surface 30 that includes a plurality of spline teeth 38 disposed around the surface thereof that engage a plurality of complementary spline teeth 8 that are disposed around the exterior surface of eyelet or component 1. Spline teeth 38 and 8 provide for a positive orientation of eyelet 8 and block 20, and therefore eyelet 1.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

We claim:

1. An orientation apparatus for mounting a component to a structure comprising:
an orientation block having a mounting surface for contacting said structure and an engagement surface for engaging said component, wherein said engagement surface is capable of being positioned in a plurality of orientations with respect to said component.

2. The apparatus of claim 1 comprising:
a mounting surface having a generally flat contour for contacting said structure.

3. The apparatus of claim 1 comprising:
an engagement surface having a generally semi-cylindrical portion for contacting a mating exterior surface of said component.

4. The apparatus as claimed in claim 3 comprising:
an engagement surface having a aperture through said semi-cylindrical portion for accepting a fitting.

5. The apparatus as claimed in claim 3 comprising:
an engagement surface having a protrusion extending from said semi-cylindrical portion for engaging a concomitant recess disposed in an exterior surface of said component.

6. The apparatus as claimed in claim 5 wherein said protrusion is a cylindrical post.

7. The apparatus as claimed in claim 3 comprising:
an engagement surface having a recessed annular surface within said semi-cylindrical portion for engaging a complementary raised annulus disposed on an exterior surface of said component.

8. An orientation apparatus for mounting a component to a structure comprising:
an orientation tab having a body portion including at least one mounting surface for contacting said structure and a semi-cylindrical engagement portion extending across at least a portion of said engaging body for engaging a mating groove in an exterior surface of said component.

9. The apparatus as claimed in claim 8 comprising:
a pair of opposed engagement tabs at opposed ends of said body portion for contacting said structure.

10. An orientation apparatus for mounting a component to a structure comprising:
a cylindrical engagement surface having a plurality of spline teeth disposed thereon said for engaging mating spline teeth in an exterior surface of said component.

11. An orientation apparatus for mounting a component to a structure comprising:
an orientation block having a body and a pair of mounting tabs on opposed ends of said body for contacting said structure, said body having a groove engagement portion for engaging an annular groove disposed in said component, wherein said groove engagement portion is capable of being positioned in a plurality of orientations with respect to said component.
